(19) United States
(12) Patent Application Publication
(10) Pub. No.: US 2021/0240831 A1
(43) Pub. Date: Aug. 5, 2021

(54) SYSTEMS AND METHODS FOR INTEGRITY VERIFICATION OF SECONDARY FIRMWARE WHILE MINIMIZING BOOT TIME

(71) Applicant: Dell Products L.P., Round Rock, TX (US)

(72) Inventors: Garrett B. ONCALE, Pflugerville, TX (US); Zhaohui YU, Cedar Park, TX (US)

(73) Assignee: Dell Products L.P., Round Rock, TX (US)

(21) Appl. No.: 16/779,911

(22) Filed: Feb. 3, 2020

(51) Int. Cl. G06F 21/57; G06F 9/4401; G06F 9/445; G06F 8/65

(52) U.S. Cl. CPC G06F 21/572; G06F 21/577; G06F 8/65; G06F 9/44578; G06F 9/4406

(57) ABSTRACT

An information handling system may include a processor and a program of instructions embodied on non-transitory computer readable media, the instructions, when read and executed, for causing the processor to perform integrity verification of a secondary firmware image that serves as a backup to a primary firmware image of an information handling resource by performing a plurality of individual integrity verifications wherein each of the plurality of individual integrity verifications is performed on a respective portion of the secondary firmware image in a manner that minimizes a boot time for the information handling system and determining that integrity verification of the secondary firmware image failed and initiating recovery of the secondary firmware image if one of the plurality of individual integrity verifications fails.

### TECHNICAL FIELD

The present disclosure relates in general to information handling systems, and more particularly to methods and systems for integrity verification of second firmware in an information handling system while minimizing boot time.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The use of dual firmware images for components of an information handling system is becoming increasingly common in order to support resiliency of the firmware. Using traditional approaches, methods exist for checking integrity status and recovering a primary firmware image, but existing approaches offer no solutions for checking the integrity status of a secondary/backup firmware image and recovering the secondary/backup firmware image without increasing the boot time.

Thus, if a secondary firmware image becomes corrupted, no integrity check may be performed to discover the corrupted status. Accordingly, when a primary firmware is corrupted, it may be restored with corrupted secondary firmware data/instructions, and no information may be known as to why the recovery failed. In some instances, the information handling system may be in a worse state than right before the attempt to recover to the secondary firmware image (e.g., a corrupted boot block on the secondary firmware image no longer allows the information handling system to boot).

Further, is may be desirable for user experience to minimize boot time of an information handling system. Using the same approach that is used for integrity checking of a primary firmware image to perform integrity checking of a secondary firmware image may be undesirable as it may contribute significantly to boot time.

### SUMMARY

In accordance with the teachings of the present disclosure, the disadvantages and problems associated with existing approaches for verification of secondary firmware integrity may be reduced or eliminated.

In accordance with embodiments of the present disclosure, an information handling system may include a processor and a program of instructions embodied on non-transitory computer readable media, the instructions, when read and executed, for causing the processor to perform integrity verification of a secondary firmware image that serves as a backup to a primary firmware image of an information handling resource by performing a plurality of individual integrity verifications wherein each of the plurality of individual integrity verifications is performed on a respective portion of the secondary firmware image in a manner that minimizes a boot time for the information handling system and determining that integrity verification of the secondary firmware image failed and initiating recovery of the secondary firmware image if one of the plurality of individual integrity verifications fails.

In accordance with these and other embodiments of the present disclosure, a method may include performing integrity verification of a secondary firmware image that serves as a backup to a primary firmware image of an information handling resource integral to an information handling system by performing a plurality of individual integrity verifications wherein each of the plurality of individual integrity verifications is performed on a respective portion of the secondary firmware image in a manner that minimizes a boot time for the information handling system and determining that integrity verification of the secondary firmware image failed and initiating recovery of the secondary firmware image if one of the plurality of individual integrity verifications fails.

In accordance with these and other embodiments of the present disclosure, an article of manufacture may include a processor and a non-transitory computer-readable medium and computer-executable instructions carried on the computer-readable medium, the instructions readable by a processor, the instructions, when read and executed, for causing the processor to perform integrity verification of a secondary firmware image that serves as a backup to a primary firmware image of an information handling resource integral to an information handling system by performing a plurality of individual integrity verifications wherein each of the plurality of individual integrity verifications is performed on a respective portion of the secondary firmware image in a manner that minimizes a boot time for the information handling system and determining that integrity verification of the secondary firmware image failed and initiating recovery of the secondary firmware image if one of the plurality of individual integrity verifications fails.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates a flowchart of an example method performed by a basic input/output system in connection with verifying integrity of a secondary firmware image for a management controller, in accordance with embodiments of the present disclosure;

FIG. 3 illustrates a flowchart of an example method performed by a management controller in connection with verifying integrity of a secondary firmware image for the management controller, in accordance with embodiments of the present disclosure;

FIG. 4 illustrates a flowchart of an example method performed by a basic input/output system during its initialization in connection with verifying integrity of a secondary firmware image for the basic input/output system, in accordance with embodiments of the present disclosure; and

FIG. 5 illustrates a flowchart of an example method performed by an offloaded basic input/output system process in connection with verifying integrity of a secondary firmware image for the basic input/output system, in accordance with embodiments of the present disclosure.

### DETAILED DESCRIPTION

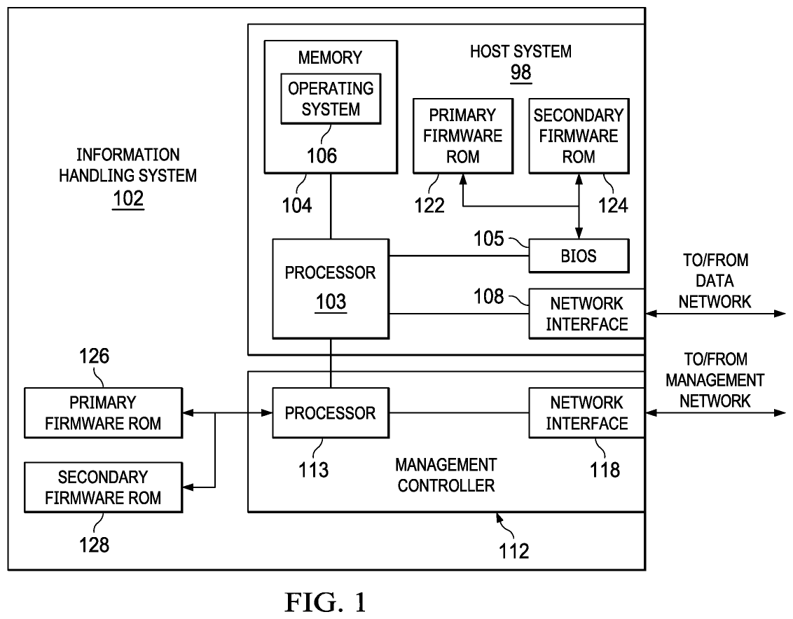

Preferred embodiments and their advantages are best understood by reference to FIGS. 1 through 5, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, information handling system 102 may comprise a personal computer. In some embodiments, information handling system 102 may comprise or be an integral part of a server. In other embodiments, information handling system 102 may comprise a portable information handling system (e.g., a laptop, notebook, tablet, handheld, smart phone, personal digital assistant, etc.). As depicted in FIG. 1, information handling system 102 may include a processor 103, a memory 104 communicatively coupled to processor 103, a BIOS 105 communicatively coupled to processor 103, a network interface 108 communicatively coupled to processor 103, a management controller 112 communicatively coupled to processor 103, a primary firmware read-only memory (ROM) 122 for BIOS 105, a secondary firmware ROM 124 for BIOS 105, a primary firmware ROM 126 for management controller 112, and a secondary firmware ROM 128 for management controller 112.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

A BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102.

Network interface 108 may comprise any suitable system, apparatus, or device operable to serve as an interface between information handling system 102 and one or more other information handling systems via an in-band management network. Network interface 108 may enable information handling system 102 to communicate using any suitable transmission protocol and/or standard. In these and other embodiments, network interface 108 may comprise a network interface card, or “NIC.” In some embodiments, network interface 108 may comprise a 10 gigabit Ethernet network interface. In these and other embodiments, network interface 108 may be enabled as a local area network (LAN)-on-motherboard (LOM) card.

In operation, processor 103, memory 104, BIOS 105, and network interface 108 may comprise at least a portion of a host system 98 of information handling system 102. Although FIG. 1 depicts host system 98, in some embodiments of the present disclosure, information handling system 102 may not include a host system 98.

Management controller 112 may be configured to provide management facilities for management of information handling system 102. Such management may be made by management controller 112 even if information handling system 102 is powered off or powered to a standby state. Management controller 112 may include a processor 113, memory, and a management network interface 118 separate from and physically isolated from data network interface 108. In certain embodiments, management controller 112 may include or may be an integral part of a baseboard management controller (BMC) or a remote access controller (e.g., a Dell Remote Access Controller or Integrated Dell Remote Access Controller). As shown in FIG. 1, management controller 112 may comprise a processor 113 and a network interface 118 communicatively coupled to processor 113.

Processor 113 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 113 may interpret and/or execute program instructions and/or process data stored in a memory and/or another component of information handling system 102 or management controller 112. As shown in FIG. 1, processor 113 may be communicatively coupled to processor 103. Such coupling may be via a Universal Serial Bus (USB), System Management Bus (SMBus), and/or one or more other communications channels.

Network interface 118 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” In some embodiments, network interface 118 may comprise a 1 gigabit Ethernet network interface.

Primary firmware ROM 122 may include any system, device, or apparatus configured to retain program instructions and/or data for a period of time, and may include non-volatile memory that retains data after power to information handling system 102 is turned off. For example, in some embodiments, primary firmware ROM 122 may comprise a flash storage device. In some embodiments, primary firmware ROM 122 may store thereon one or more firmware images, including firmware for BIOS 105, or other executable code.

Secondary firmware ROM 124 may include any system, device, or apparatus configured to retain program instructions and/or data for a period of time, and may include non-volatile memory that retains data after power to information handling system 102 is turned off. For example, in some embodiments, secondary firmware ROM 124 may comprise a flash storage device. In some embodiments, secondary ROM 124 may store thereon one or more code images, including a recovery image for the one or more code images stored on primary firmware ROM 122.

Primary firmware ROM 126 may include any system, device, or apparatus configured to retain program instructions and/or data for a period of time, and may include non-volatile memory that retains data after power to information handling system 102 is turned off. For example, in some embodiments, primary firmware ROM 126 may comprise a flash storage device. In some embodiments, primary firmware ROM 126 may store thereon one or more firmware images, including firmware for management controller 112, a bootloader for management controller 112, or other executable code.

Secondary firmware ROM 128 may include any system, device, or apparatus configured to retain program instructions and/or data for a period of time, and may include non-volatile memory that retains data after power to information handling system 102 is turned off. For example, in some embodiments, secondary firmware ROM 128 may comprise a flash storage device. In some embodiments, secondary ROM 128 may store thereon one or more code images, including a recovery image for the one or more code images stored on primary firmware ROM 126.

In addition to processor 103, memory 104, network interface 108, management controller 112, primary firmware ROM 122, secondary firmware ROM 124, primary firmware ROM 126, and secondary firmware ROM 128, information handling system 102 may include one or more other information handling resources.

In operation, BIOS 105 and/or management controller 112 may be configured to validate a secondary firmware image (e.g., stored in secondary firmware ROM 124 or secondary firmware ROM 128) by breaking up the secondary firmware image into multiple smaller blocks, performing integrity checks on each of such multiple smaller blocks using idle processor cycles, and recovering the secondary firmware image when an integrity error is found in the secondary firmware image.

To illustrate this functionality, two use cases are described below: (i) one for validating a secondary firmware image for management controller 112 (e.g., as stored in secondary ROM 128); and (ii) one for validating a secondary firmware image for BIOS 105 (e.g., as stored in secondary ROM 124). However, despite discussion of these examples below, the systems and methods similar or identical to those described herein may also be applied to firmware for components of information handling system 102 other than BIOS 105 and management controller 112.

As for validating a secondary firmware image for management controller 112, when management controller 112 initializes (e.g., from a cold boot or restart), management controller 112 may verify its primary firmware image (e.g., stored in primary firmware ROM 126), execute the primary firmware image if the primary firmware image is verified, and otherwise execute its secondary firmware image (e.g., stored in secondary firmware ROM 128). If management controller 112 executes its secondary firmware image as a result of the primary firmware image failing verification, management controller 112 may execute a “normal” recovery process to recover its primary firmware image (e.g., overwrite the primary firmware image stored in primary firmware ROM 126 with the contents of the secondary firmware image). On the other hand, if the primary firmware image executes as a result of passing verification, management controller 112 may poll for pending tasks, and when processing cycles of processor 113 occur that would otherwise be idle, management controller 112 may perform a verification check on a block of its secondary firmware image, such block being sufficiently small enough to be processed without interrupting other cycles. If an error is found during any of the verification checks of individual blocks of the secondary firmware image, management controller 112 may set an appropriate flag for recovery of the secondary firmware image to be initiated upon the next boot of management controller 112. If all individual blocks of the secondary firmware image data are checked without error, then management controller 112 may set a flag or other variable to indicate that the secondary firmware image passed verification.

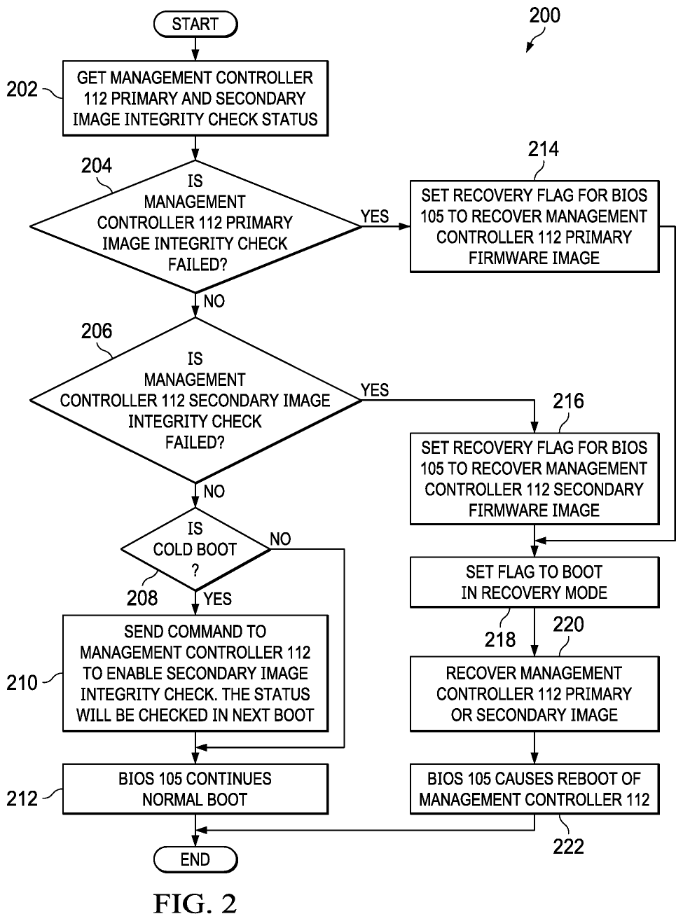

FIG. 2 illustrates a flowchart of an example method 200 performed by BIOS 105 in connection with verifying integrity of a secondary firmware image for management controller 112, in accordance with embodiments of the present disclosure. According to certain embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, BIOS 105 may read variables indicative of the integrity of the primary firmware image for management controller 112 (e.g., variable “primary image integrity check status”) and the integrity of the secondary firmware image for management controller 112 (e.g., variable “secondary image integrity check status”).

At step 204, BIOS 105 may determine if the primary image integrity check status variable indicates failure of integrity verification for the primary firmware image. If the primary image integrity check status variable indicates failure of integrity verification for the primary firmware image, method 200 may proceed to step 214. Otherwise, method 200 may proceed to step 206.

At step 206, BIOS 105 may determine if the secondary image integrity check status variable indicates failure of integrity verification for the secondary firmware image. If the secondary image integrity check status variable indicates failure of integrity verification for the secondary firmware image, method 200 may proceed to step 216. Otherwise, method 200 may proceed to step 208.

At step 208, BIOS 105 may determine if the current boot of information handling system 102 is a cold boot. If the current boot of information handling system 102 is a cold boot, method 200 may proceed to step 210. Otherwise, method 200 may proceed to step 212.

At step 210, BIOS 105 may send a command to management controller 112 to enable a secondary firmware image integrity check, which may cause management controller 112 to perform a secondary firmware image integrity check on the next boot of management controller 112.

At step 212, BIOS 105 may continue the normal boot process for information handling system 102. After completion of step 212, method 200 may end.

At step 214, responsive to the primary image integrity check status variable indicating failure of integrity verification for the primary firmware image, BIOS 105 may set a recovery flag or other variable for BIOS 105 to recover the primary firmware image. After completion of step 214, method 200 may proceed to step 218.

At step 216, responsive to the secondary image integrity check status variable indicating failure of integrity verification for the secondary firmware image, BIOS 105 may set a recovery flag or other variable for BIOS 105 to recover the secondary firmware image.

At step 218, BIOS 105 may set a flag or other variable to cause management controller 112 to boot into a recovery mode for recovering the corrupted (first or second) firmware image. At step 220, the corrupted firmware image may be recovered. At step 222, BIOS 105 may cause reboot of management controller 112. After completion of step 222, method 200 may end.

Although FIG. 2 discloses a particular number of steps to be taken with respect to method 200, it may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102, components thereof or any other system operable to implement method 200. In certain embodiments, method 200 may be implemented partially or fully in software and/or firmware embodied in computer-readable media.

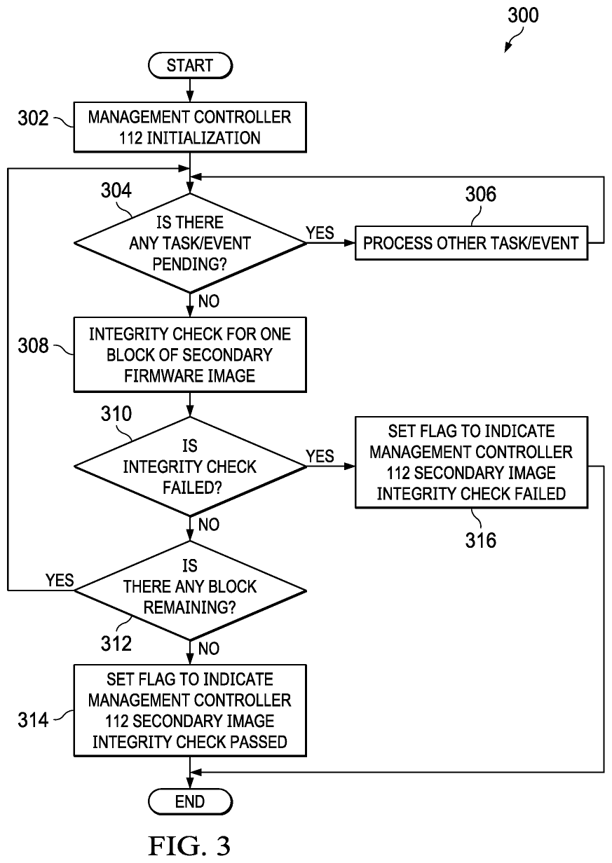

FIG. 3 illustrates a flowchart of an example method 300 performed by management controller 112 in connection with verifying integrity of a secondary firmware image for management controller 112, in accordance with embodiments of the present disclosure. According to certain embodiments, method 300 may begin at step 302. As noted above, teachings of the present disclosure may be implemented in a variety of configurations of information handling system 102. As such, the preferred initialization point for method 300 and the order of the steps comprising method 300 may depend on the implementation chosen.

At step 302, management controller 112 may initialize. At step 304, management controller 112 may determine if there is any task or event pending for processor 113. If a task or event is pending, method 300 may proceed to step 306. Otherwise, method 300 may proceed to step 308.

At step 306, processor 113 may process the task or event. After completion of step 306, method 300 may proceed again to step 304.

At step 308, in response to no task or event pending for processor 113, management controller 112 may use processor 113 to perform an integrity check for a block of the secondary firmware image. At step 310, management controller 112 may determine if the integrity check for the block of the secondary firmware image failed. If the integrity check failed, method 300 may proceed to step 316. Otherwise, method 300 may proceed to step 312.

At step 312, responsive to the integrity check of the block of the secondary firmware image passing, management controller 112 may determine if any more blocks of the secondary firmware image need to be verified for integrity. If no further blocks need to be verified, method 300 may proceed to step 314. Otherwise, method 300 may proceed again to step 304.

At step 314, responsive to all blocks of the secondary firmware image passing their individual integrity checks, management controller 112 may set a flag or other variable indicating that the integrity check of its secondary firmware image has passed. After completion of step 314, method 300 may end.

At step 316, responsive to any block of the secondary firmware image failing its individual integrity checks, management controller 112 may set a flag or other variable indicating that the integrity check of its secondary firmware image has failed. The setting of such flag to indicate failure may cause BIOS 105 to repair the secondary firmware image on a subsequent boot. After completion of step 316, method 300 may end.

Although FIG. 3 discloses a particular number of steps to be taken with respect to method 300, it may be executed with greater or fewer steps than those depicted in FIG. 3. In addition, although FIG. 3 discloses a certain order of steps to be taken with respect to method 300, the steps comprising method 300 may be completed in any suitable order.

Method 300 may be implemented using information handling system 102, components thereof or any other system operable to implement method 300. In certain embodiments, method 300 may be implemented partially or fully in software and/or firmware embodied in computer-readable media.

As for validating a secondary firmware image for BIOS 105 (e.g., BIOS boot block firmware), when BIOS 105 initializes it may verify its primary firmware image (e.g., stored in primary firmware ROM 122), execute the primary firmware image during power-on/self-test of BIOS 105 if the primary firmware image is verified, and otherwise execute its secondary firmware image (e.g., stored in secondary firmware ROM 124) during power-on/self-test of BIOS 105. If the secondary firmware image executes, verification failure of the primary firmware image should lead to a standard recovery process for the primary firmware image. If the primary firmware image executes, BIOS 105 may verify a portion of the secondary firmware image. For example, in some embodiments, BIOS 105 may use UEFI multiple processor (MP) protocol to offload integrity check processing to an application processor for BIOS 105 in non-block mode in the early driver execution environment (DXE) phase of BIOS 105. To minimize boot time, BIOS 105 may only verify one firmware volume of the secondary firmware image in each boot session. If an error is found during integrity checking, BIOS 105 may log the error, leading to recovery of the secondary firmware image on the next boot session.

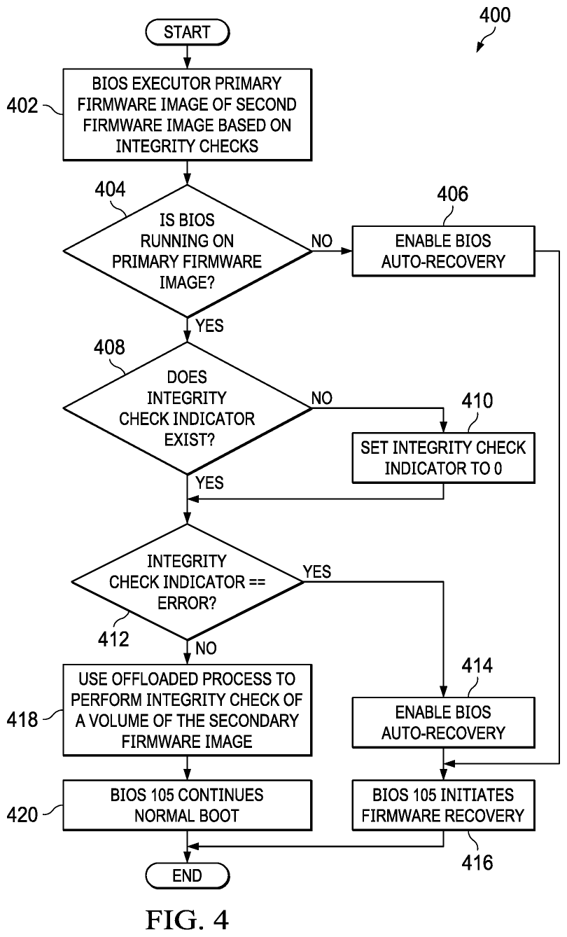

FIG. 4 illustrates a flowchart of an example method 400 performed by BIOS 105 during its initialization in connection with verifying integrity of a secondary firmware image for BIOS 105, in accordance with embodiments of the present disclosure. According to certain embodiments, method 400 may begin at step 402. As noted above, teachings of the present disclosure may be implemented in a variety of configurations of information handling system 102. As such, the preferred initialization point for method 400 and the order of the steps comprising method 400 may depend on the implementation chosen.

At step 402, BIOS 105 may execute its primary firmware image or its secondary firmware image based on results of integrity checks for the primary firmware image. At step 404, BIOS 105 may determine if it is the primary firmware image. If BIOS is not running its primary firmware image (e.g., indicating that integrity checks for the primary firmware image failed), method 400 may proceed to step 406. Otherwise, method 400 may proceed to step 408.

At step 406, BIOS 105 may enable BIOS auto recovery due to the failure of integrity checks for the primary firmware image. After completion of step 406, method 400 may proceed to step 416.

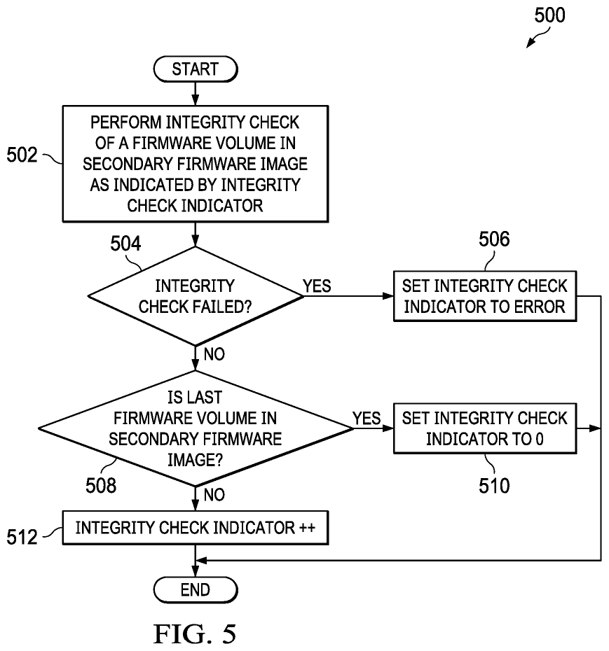

At step 408, BIOS 105 may determine if an integrity check indicator variable exists. Such integrity check indicator variable may be set during an offloaded BIOS process described below with respect to method 500 and FIG. 5, and may indicate whether an integrity check for the secondary firmware image has experienced an error, and in the absence of an error condition, may indicate the last volume or other portion of the secondary firmware image the offloaded process has verified. If the integrity check indicator variable exists, method 400 may proceed to step 412. Otherwise, method 400 may proceed to step 410.

At step 410, in the absence of an integrity check indicator variable, BIOS 105 may initialize such integrity check indicator variable to zero or other suitable initial value.

At step 412, BIOS 105 may determine if the integrity check indicator variable indicates that an error occurred during a previous boot of BIOS 105. If the integrity check indicator variable indicates that an error occurred during a previous boot of BIOS 105, method 400 may proceed to step 414. Otherwise, method 400 may proceed to step 418.

At step 414, BIOS 105 may enable BIOS auto recovery due to the failure of an integrity check for the secondary firmware image. At step 416, BIOS 105 may initiate firmware recovery of the primary firmware image or secondary firmware image, as appropriate.

At step 418, BIOS 105 may use an offloaded process (e.g., method 500 depicted in FIG. 5 and described below) to perform integrity checks of a volume of the secondary firmware image. At step 420, BIOS 105 may continue the normal boot process for information handling system 102.

Although FIG. 4 discloses a particular number of steps to be taken with respect to method 400, it may be executed with greater or fewer steps than those depicted in FIG. 4. In addition, although FIG. 4 discloses a certain order of steps to be taken with respect to method 400, the steps comprising method 400 may be completed in any suitable order.

Method 400 may be implemented using information handling system 102, components thereof or any other system operable to implement method 400. In certain embodiments, method 400 may be implemented partially or fully in software and/or firmware embodied in computer-readable media.

FIG. 5 illustrates a flowchart of an example method 500 performed by an offloaded BIOS process in connection with verifying integrity of a secondary firmware image for BIOS 105, in accordance with embodiments of the present disclosure. According to certain embodiments, method 500 may begin at step 502. As noted above, teachings of the present disclosure may be implemented in a variety of configurations of information handling system 102. As such, the preferred initialization point for method 500 and the order of the steps comprising method 500 may depend on the implementation chosen.

At step 502, BIOS 105 may perform an integrity check of a firmware volume of the secondary firmware image, as such firmware volume is indicated by the integrity check indicator variable. At step 504, BIOS 105 may determine whether the integrity check failed. If the integrity check failed, method 500 may proceed to step 506. Otherwise, method 500 may proceed to step 508.

At step 506, BIOS 105 may set the integrity check indicator variable to indicate a verification error, thus causing recovery of the secondary firmware image during the next boot session of BIOS 105 (e.g., during execution of method 400 during such next boot session). After completion of step 506, method 500 may end.

At step 508, BIOS 105 may determine if the firmware volume checked at step 502 is the last firmware volume of the secondary firmware image. If the firmware volume checked at step 502 is the last firmware volume of the secondary firmware image, method 500 may proceed to step 510. Otherwise, method 500 may proceed to step 512.

At step 510, BIOS 105 may set the integrity check indicator variable to zero or another appropriate value, such that during execution of method 500 on the next boot of BIOS 105, integrity checks begin again at the first firmware volume of the secondary firmware image. After completion of step 510, method 500 may end.

At step 512, BIOS 105 may increment the integrity check indicator variable to its next value, such that during execution of method 500 on the next boot of BIOS 105, integrity checks begin again at the next firmware volume of the secondary firmware image. After completion of step 512, method 500 may end.

Although FIG. 5 discloses a particular number of steps to be taken with respect to method 500, it may be executed with greater or fewer steps than those depicted in FIG. 5. In addition, although FIG. 5 discloses a certain order of steps to be taken with respect to method 500, the steps comprising method 500 may be completed in any suitable order.

Method 500 may be implemented using information handling system 102, components thereof or any other system operable to implement method 500. In certain embodiments, method 500 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a processor; and
a program of instructions embodied on non-transitory computer readable media, the instructions, when read and executed, for causing the processor to perform integrity verification of a secondary firmware image that serves as a backup to a primary firmware image of an information handling resource by:
performing a plurality of individual integrity verifications wherein each of the plurality of individual integrity verifications is performed on a respective portion of the secondary firmware image in a manner that minimizes a boot time for the information handling system; and
determining that integrity verification of the secondary firmware image failed and initiating recovery of the secondary firmware image if one of the plurality of individual integrity verifications fails.

2. The information handling system of claim 1, wherein the instructions may further cause the processor to determine that integrity verification of the secondary firmware image passed if all of the plurality of individual integrity verifications pass.

3. The information handling system of claim 1, wherein the instructions may further cause the processor to perform the plurality of individual integrity verifications during a single boot session of the information handling system.

4. The information handling system of claim 3, wherein the instructions may further cause the processor to perform the plurality of individual integrity verifications during cycles of the processor for which the processor would otherwise be idle.

5. The information handling system of claim 1, wherein the instructions may further cause the processor to perform the plurality of individual integrity verifications across multiple boot sessions of the information handling system.

6. The information handling system of claim 1, wherein the instructions may further cause the processor to perform a single one of the plurality of individual integrity verifications during a boot session of the information handling system.

7. A method comprising:
performing integrity verification of a secondary firmware image that serves as a backup to a primary firmware image of an information handling resource integral to an information handling system by:
performing a plurality of individual integrity verifications wherein each of the plurality of individual integrity verifications is performed on a respective portion of the secondary firmware image in a manner that minimizes a boot time for the information handling system; and
determining that integrity verification of the secondary firmware image failed and initiating recovery of the secondary firmware image if one of the plurality of individual integrity verifications fails.

8. The method of claim 7, further comprising determining that integrity verification of the secondary firmware image passed if all of the plurality of individual integrity verifications pass.

9. The method of claim 7, further comprising performing the plurality of individual integrity verifications during a single boot session of the information handling system.

10. The method of claim 9, further comprising performing the plurality of individual integrity verifications during cycles of a processor for which the processor would otherwise be idle.

11. The method of claim 7, further comprising performing the plurality of individual integrity verifications across multiple boot sessions of the information handling system.

12. The method of claim 7, further comprising performing a single one of the plurality of individual integrity verifications during a boot session of the information handling system.

13. An article of manufacture comprising:
a processor; and
a non-transitory computer-readable medium; and
computer-executable instructions carried on the computer-readable medium, the instructions readable by a processor, the instructions, when read and executed, for causing the processor to:
perform integrity verification of a secondary firmware image that serves as a backup to a primary firmware image of an information handling resource integral to an information handling system by:
performing a plurality of individual integrity verifications wherein each of the plurality of individual integrity verifications is performed on a respective portion of the secondary firmware image in a manner that minimizes a boot time for the information handling system; and
determining that integrity verification of the secondary firmware image failed and initiating recovery of the secondary firmware image if one of the plurality of individual integrity verifications fails.

14. The article of claim 13, wherein the instructions may further cause the processor to determine that integrity verification of the secondary firmware image passed if all of the plurality of individual integrity verifications pass.

15. The article of claim 13, wherein the instructions may further cause the processor to perform the plurality of individual integrity verifications during a single boot session of the information handling system.

16. The article of claim 15, wherein the instructions may further cause the processor to perform the plurality of individual integrity verifications during cycles of the processor for which the processor would otherwise be idle.

17. The article of claim 14, wherein the instructions may further cause the processor to perform the plurality of individual integrity verifications across multiple boot sessions of the information handling system.

18. The article of claim 13, wherein the instructions may further cause the processor to perform a single one of the plurality of individual integrity verifications during a boot session of the information handling system.
